(19) United States
(12) Patent Application Publication
(10) Pub. No.: US 2007/0195360 A1
(43) Pub. Date: Aug. 23, 2007

(54) IMAGE FORMING APPARATUS

(75) Inventor: Osamu Sagata, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION

(21) Appl. No.: 11/669,415

(22) Filed: Jan. 31, 2007

(30) Foreign Application Priority Data
Feb. 23, 2006 (JP) 2006-046791

(51) Int. Cl. G06F 3/12

(52) U.S. Cl. 358/1.15

(57) ABSTRACT

An image data generation unit generates image data based on input printing information, an image data storage unit for storing the image data, a received data analysis unit for making a judgment that reception of a packet of printing information is received, a printing control unit for giving notification of printing preparation completion and ordering printing initiation via a transmission unit upon completion of the generation of the image data based on packet of printing information judged to be received, and an image formation unit performs, based on the order of the printing control unit, a printing process based on the packet of printing information.

### BACKGROUND OF THE INVENTION

1. Field of the Invention

The present invention relates to an image forming apparatus that can be used and shared by many users via a LAN (Local Area Network) and the like.

2. Description of Related Art

In recent years, image forming apparatus, represented by printers, have become connected to a large number of computers via a LAN or the like, making the image forming apparatus usable by and shareable by many users. In such a connection formation, as compared to a one to one connection formation, it is common for there to be a large distance between the computer ordering the printing and the image forming apparatus, thereby creating an inconvenience for the user by making it difficult to quickly know the condition of the image forming apparatus. To solve this kind of inconvenience, technology has been developed to inform the user by sending notification of the completed condition of the printing from the image apparatus to the computer that executed the printing command at a time when printing is completed (see International Patent Application publication 2001-325089).

However, authenticated printing, manual printing, and the like have the purpose of making a first initiation of printing dependent on manipulation of the image forming apparatus by a user, thereby creating a situation where, because of the printing condition of another user, the user must wait for a long time until output of the printing is completed.

### SUMMARY OF THE INVENTION

The present invention contains an image data generation unit for generating image data based on input printing information, an image data storage unit for storing the image data, a reception completion judgment unit for making a judgment as to whether reception of a packet of printing information is completed, a notification unit for giving notification of printing preparation completion upon completion of the image data generation based on the packet of the printing information judged to be received, a print order unit for receiving a printing initiation request based on the notification of printing preparation completion and ordering initiation of printing, and an image formation unit for performing a printing process, based on orders from the print order unit, of the image data based on the packet of printing information.

The image formation apparatus according to the present invention can minimize the time spent by the user near the image forming apparatus waiting for the printing output because the user may leave his seat after receiving the notification from the notification unit that printing preparation is complete.

### BRIEF DESCRIPTION OF THE DRAWINGS

This invention may take physical form in certain parts and arrangements of parts, a preferred embodiment and method of which will be described in detail in this specification and illustrated in the accompanying drawings which form a part hereof, and wherein:

FIG. 1 is a block diagram of the printing system including the printer according to the present invention;

FIG. 2 is a block diagram of the printer of the first embodiment;

FIG. 3 is an explanatory diagram of printing information;

FIG. 4 is an explanatory diagram showing an example display of the host computer of the first embodiment;

FIG. 5 is a flow chart describing the performance of the printer of the first embodiment;

FIG. 6 is a block diagram of the printer of the second embodiment;

FIG. 7 is a flow chart describing the performance of the printer of the second embodiment;

FIG. 8 is a block diagram of the printer of the third embodiment;

FIG. 9 is an explanatory diagram showing an example display of the host computer of the third embodiment; and

FIG. 10 is a flow chart describing the performance of the printer of the third embodiment.

### DESCRIPTION OF PREFERRED EMBODIMENTS

### First Embodiment

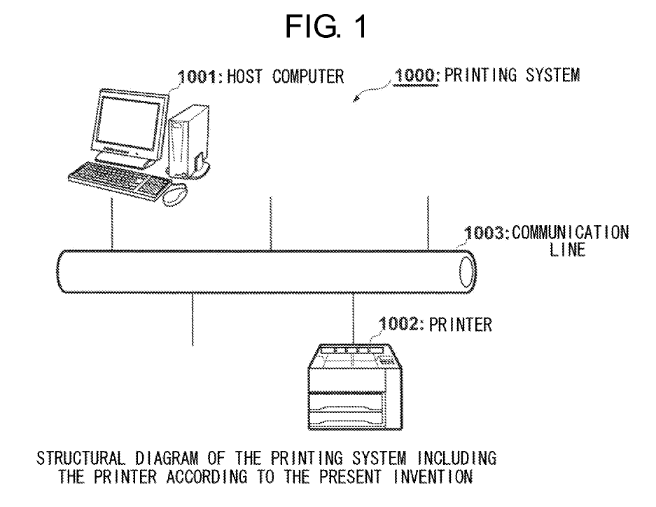

FIG. 1 is a block diagram of the printing system including a printer according to the present invention. As shown in FIG. 1, a host computer 1001 is a computing machine, for example a personal computer, generates printing information (information recognizable by printers and described by a page-description language), and is a terminal apparatus that sends the printing information to the printer 1002. The printer 1002 is a printing apparatus such as an ink-jet printer or an electrophotographic printer. A communication line 1003 is an internal network such as the LAN. A printing system 1000 is structured as shown in FIG. 1, such that the host computer 1001 and the and the printer 1002 serving as the image forming apparatus are connected via the communication line 1003. The following is a description of the printer 1002 as the image forming apparatus of the first embodiment in the printing system.

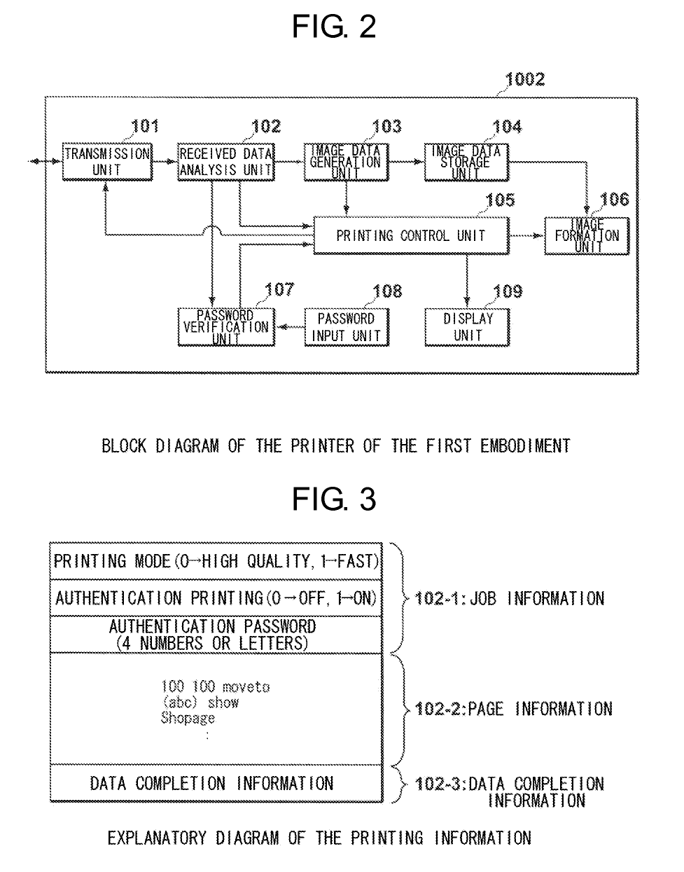

FIG. 2 is a block diagram of the printer of the first embodiment. As shown in FIG. 2, the printer 1002 according to the first embodiment is equipped with a transmission unit 101, a received data analysis unit 102, an image data generation unit 103, an image data storage unit 104, a printing control unit 105, an image formation unit 106, a password verification unit 107, a password input unit 108, and a display unit 109.

The transmission unit 101 is a portion that operates in charge of the interface communicatively connected to each network or USB (Universal Serial Bus). Further, in the present embodiment, the reception of a packet of the printing information from the prescribed host computer 1001 (FIG. 1) is completed based on instruction from the printing control unit 105. Such printing information is divided into each unit of a print job, namely a “packet”, but multiple print jobs received from the same user can also be a packet. Upon completing generation of the image data based on the packet of printing information, the image data generation unit 103 serves as a portion to notify the host computer 1001 that the printing preparation is complete.

The received data analysis unit 102 is a portion that receives the printing information received by the transmission unit 101 via the various networks and USBs, separates and analyzes every unit of the print job, and sends the acquired various information to the portion having the prescribed function to continue the process. Here, as an example, the received data analysis unit 102 is described using various information acquired by units of the print job.

FIG. 3 is an explanatory diagram of the printing information. FIG. 3 shows the content of the print job. The print job shown in FIG. 3 includes job information 102-1 designating the function of the specific apparatus, page information 102-2 describing the content of the page to be printed, and data completion information 102-3 showing the completion of the printing data. In the job information 102-1, information applicable to all of the print jobs is designated, such as print mode (high-quality, fast, etc.) and authentication printing (on/off, requesting a password in a case of “on”, etc.).

From the print job described above, the received data analysis unit 102 acquires the job information 102-1, page information 102-2, and data completion information 102-3. Based on the acquired information, a judgment is made as to whether the reception of the package of printing information is complete and, in a case of a special authentication printing process, whether the authentication information added to the package of printing information is acquired. The page information 102-2 is sent to the image data generation unit 103 and the authentication information added to the package of printing information is sent to the password verification unit 107.

Returning to FIG. 2, the image data generation unit 103 is a portion that receives the page information 102-2 of every print job from the received data analysis unit 102, generates the image data, segments the image data of every print job, and stores the image data in the image data storage unit 104.

The image data storage unit 104 is a storage apparatus such as a hard disk or a RAM (Random Access Memory) that receives the image data from the image data generation unit 103 and stores the image data of every print job.

The printing control unit 105 is a portion that, in an unauthenticated printing process, controls the image formation unit 106 to perform the printing process upon completion of the generation of the page data by the image data generation unit 103. On the other hand, in an authenticated printing process, the printing control unit 105 is a portion that controls the image generation unit 106 to perform the printing process of the authenticated printing upon receiving verification success notification from the password verification unit 107. Further, upon receiving the notification of the completed generation of the image data based on the packet of printing information from the image data generation unit 103, the printing control unit 105 is a portion that instructs the transmission unit 101 to send the notification of completed printing preparation to the host computer 1001.

The image formation unit 106 is a portion that, under the control of the printing control unit 105, receives the image data, performs the printing process on a prescribed recording paper, and outputs the printed paper. For example, in a case of an electrophotographic printer, an electrostatic latent image based on the image data is formed on a photosensitive drum; the electrostatic latent image is developed by toner; the developed toner image is transferred and affixed to the prescribed recording paper; and the printing process is completed.

The password verification unit 107 is a portion that receives and verifies the password included in the print job (authenticated printing) from the received data analysis unit 102 and the added password required to initiate printing, which is input by the user, form the password input unit 108, makes a judgment as to whether both of the passwords are identical, and sends notification of the judgment result to the printing control unit 105.

The password input unit 108 is a touch panel, switch, or the like and is a portion that receives the password input by the user. In the present embodiment, the input of the password by the user corresponds to the printing initiation requirement by the user because the user inputs the password to initiate printing.

The display unit 109 is a liquid crystal display, LED display, or the like and is a portion that displays the condition of the apparatus to inform the user.

In addition, as seen in the description of the portions in the aforementioned structure, the function of the received data analysis unit 102, the image data generation unit 103, the printing control unit 105, and the password verification unit 107, activated or generated by the execution of a prescribed control program previously stored in a ROM (Read Only Memory), not shown, by a CPU (Microprocessor), not shown, is represented in a block format.

In the operation of the printer 1002 (FIG. 1) according to the present embodiment, first, a general explanation will be given using FIG. 2. Then, a detailed explanation will be given using the flow chart.

In a case where authenticated printing is executed, the printer 1002 (FIG. 1) in the present embodiment does not initiate printing during the period from when the received data analysis unit 102 detects the data completion information 102-3 of the print job received via the communication line 103 from the host computer 1001 (FIG. 1), to when the generation of the image data for all of the pages is complete. Upon completion of the generation of the image data for all of the pages, a message of the completed status is sent from the transmission unit 101 to the host computer 1001 (FIG. 1) via the communication line 103.

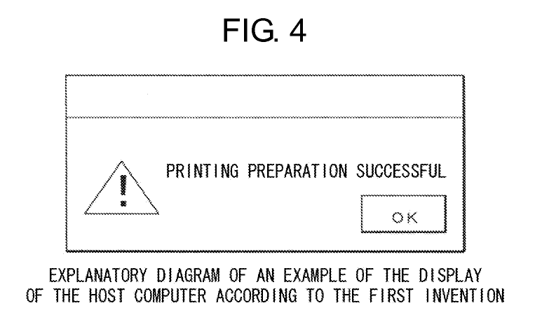

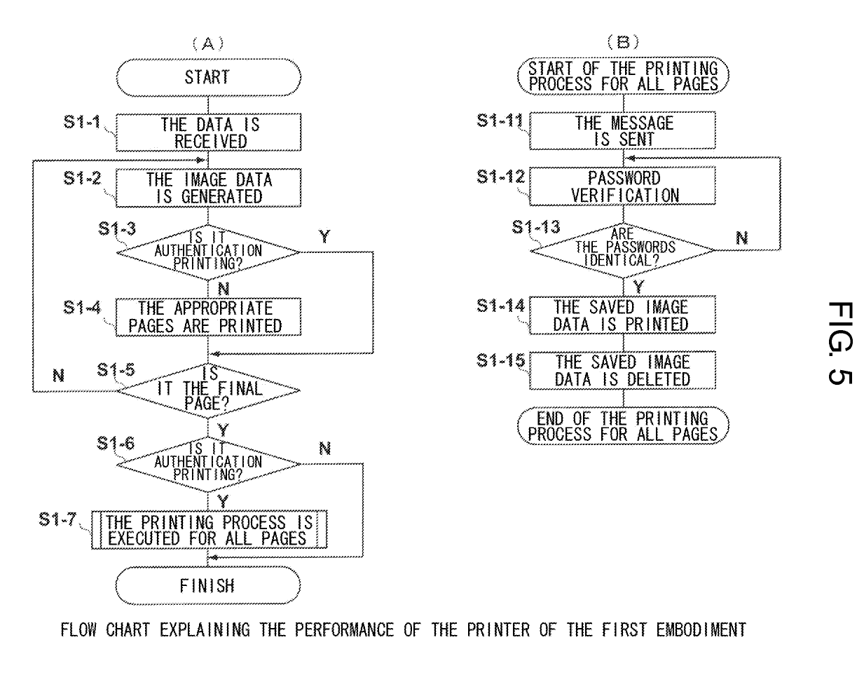

FIG. 4 is an explanatory diagram showing an example display of the host computer of the first embodiment.

The diagram displays an example of the message sent from the transmission unit 101 to the host computer 1001 via the communication line 1003 (FIG. 1) upon completion of the generation of the image data for all of the pages.

The user positioned near the host computer 1001 (FIG. 1) moves near the printer 1002 (FIG. 1) after confirming the display shown in FIG. 4, and executes the printing initiation request by inputting his personal password into the password input unit 108. The password verification unit 107 verifies the password received from the password verification unit 107 and the password received from the received data analysis unit 102.

Upon detecting that both passwords are identical, the password verification unit 107 sends the verification success notification to the printing control unit 105. Upon receiving the verification success notification, the printing control unit 105 controls the image formation unit 106 to initiate the printing process. At this time, a waiting time of user who is away can be minimized because the image data of all the pages is already formed and stored in the image data storage unit 104. The following is detailed explanation using the flow chart.

FIG. 5 is a flow chart describing the performance of the printer of the first embodiment.

(A) is a flow chart showing all of the performances and (B) is a flow chart showing process of printing all of the pages.

The overall performance of the printer 1002 (FIG. 2) will be specifically described in order from step S1-1 to step S1-7 using the flow chart (A).

Step S1-1

The transmission unit 101 (FIG. 2) receives the print job from the host computer 1001 (FIG. 1) via the communication line 1003 (FIG. 1). From the print job, the job information 102-1 is analyzed (and the password is acquired if included) by the received data analysis unit 102 (FIG. 2) and the page information 102-2 (FIG. 3), which follows after, is sent to the image data generation unit 103 (FIG. 2).

Step S1-2

The image data generation unit 103 (FIG. 2) generates one page of image data based on the received page information 102-2 (FIG. 3) and stores the generated image data in the image data storage unit 104 (FIG. 2).

Step S1-3

In a case where the received data analysis unit 102 (FIG. 2) does not acknowledge the authenticated printing at the aforementioned step S1-1, the process proceeds to step S1-4. In a case where the authenticated printing is acknowledged, the process proceeds to step S1-5.

Step S1-4

Under the control of the printing control unit 105 (FIG. 2), the image formation unit 106 reads the image data from the image data storage unit 104 (FIG. 2) and performs the printing process for the appropriate page.

Step S1-5

Upon detection by the received data analysis unit 102 (FIG. 2) of the data completion information 102-3 (FIG. 3) from the print job, the process proceeds to step S1-6. The steps S1-2 through S1-5 are repeated until the data completion information 102-3 (FIG. 3) is detected.

Step S1-6

In a case where the received data analysis unit 102 (FIG. 2) does not acknowledge the authenticated printing at the aforementioned step S1-1, the process flow is finished. In a case where the authenticated printing is acknowledged, the process proceeds to step S1-7.

Step S1-7

The printing process for all of the pages (step S1-11 through step S1-15, described later) is performed and the process flow is finished.

Next, the overall performance of the printing process of all of the pages will be specifically described in order from step S1-11 to step S1-15 using the flow chart (B).

Step S1-11

When the image data generation unit 103 (FIG. 2) generates the image data of all of the pages based on the page information 102-2 (FIG. 3) and completes the storage of the image data in the image data storage unit 104, the transmission unit 101 (FIG. 2), based on the instructions of the printing control unit 105 (FIG. 2) sends the notification of printing preparation completion to the host computer 1001 (FIG. 1) via the communication line 1003 (FIG. 1) and displays the message shown in FIG. 4 in the display unit of the host computer 1001 (FIG. 1), not shown.

Step S1-12

The user who receives the notification of printing preparation completion leaves his seat, moves near to the printer 1002 (FIG. 1), and executes the printing request by inputting his personal password into the password input unit 108 (FIG. 2). Upon receiving the password input by the user via the password input unit 108 (FIG. 2), the password verification unit 107 (FIG. 2) verifies this password and the password acquired by the received data analysis unit 102 (FIG. 2) as shown in step S1-1.

Step S1-13

In a case where both of the passwords are identical, the password verification unit 107 sends the verification success notification to the printing control unit 105 (FIG. 2) and proceeds to step S1-14. In a case where the passwords are not identical, the process returns to step S1-12.

Step S1-14

Upon receiving the verification success notification, the printing control unit 105 (FIG. 2) controls the image formation unit 106 (FIG. 2) to initiate the printing process.

Step S1-15

The printing control unit 105 (FIG. 2) deletes the image data stored in the image data storage unit 104 (FIG. 2) and finishes the process flow.

As described above, the present invention can achieve the benefit of minimizing the time that the user must wait near the printer 1002 (FIG. 1) for the output because the user may leave his seat after receiving the notification of printing preparation completion, like that shown in FIG. 4.

After receiving the notification of printing preparation completion, the user may leave his seat after the prescribed time has passed (for example, the waiting time can be increased by the time for warm up and the like). Further, the process proceeds to step S1-6 upon detection of the data completion information 102-3 (FIG. 3) from the print job by the received data analysis unit 102 (FIG. 2) at step S1-5, but the process is not necessarily limited to this example. That is, a case where the pages to follow cannot be received even after the prescribed time has passed may serve as the data completion.

In the description above, the transmission unit 101 (FIG. 2) sends a message like that shown in FIG. 4 to the host computer 1001 (FIG. 1), but the present invention is not limited to this example. For example, a lamp may flicker or a buzzer may sound. Further, in the present embodiment, with the password input for authenticated printing as the printing instructions, the password input unit 108 (FIG. 2) receives the printing initiation request of the user, but the printing initiation request of the user may also be, for example, the user manually setting paper in the tray.

In the description above, in a case where the printer 1002 is a photoelectric printer equipped with a fusion device containing a heat roller, the following is further possible. That is, the printer 1002 activates a timer, serving as a time measurement section, along with notifying the host computer 1001 (FIG. 1) about the printing preparation completion. Next, the temperature of the heat roller of the fusion device is set to the temperature appropriate for fusing at the time of printing. In a case where the password input is recognized before the timer reaches the previously decided time (for example, five minutes), verification is completed and printing is immediately initiated. In a case where no other printing data is received and no password is input for a certain period of time, power saving measures, such as lowering the temperature of the heat roller, can be undertaken. In the manner described above, the data to be printed can be neatly prepared and, because the warm up time of the heat roller is removed, the waiting time can be further shortened.

### Second Embodiment

In the present embodiment, the image data generated by the image data generation unit is encoded and stored in the image data storage unit, so that the size of the image data can be reduced.

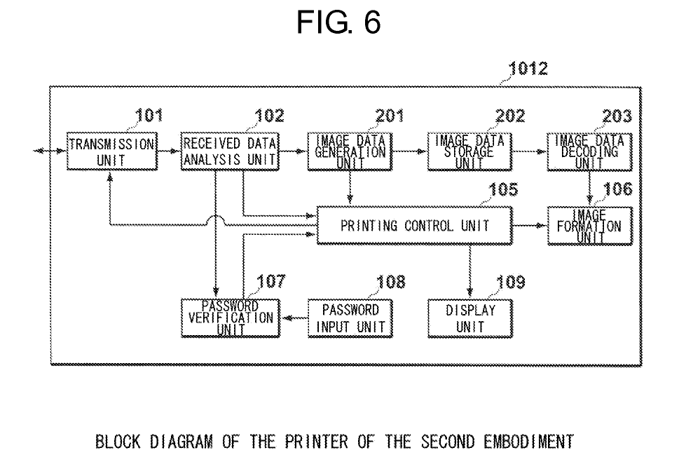

FIG. 6 is a block diagram of the printer in the second embodiment.

As shown in the diagram, the printer 1002 of the first embodiment is equipped with the transmission unit 101, the received data analysis unit 102, an image data generation unit 201, an image data storage unit 202, the printing control unit 105, the image formation unit 106, the password verification unit 107, the password input unit 108, the display unit 109, and an image data decoding unit 203. Below, only the portions different from those of the first embodiment will be described in detail. Portions that are identical to those of the first embodiment are given the same numbering and the description is omitted.

The image data generation unit 201 is a portion that receives the page information 102-2 (FIG. 3) of every print job from the received data analysis unit 102, generates the image data, encodes the image data, divides the image data for every print job, and stores the image data in the image data storage unit 202.

The image data storage unit 202 is a storage apparatus such as a RAM (Random Access Memory) or hard disk for storing the image data for every print job. The image data storage unit 202 receives the encoded image data from the image data generation unit 201.

The image data decoding unit 203 is a portion that receives the encoded image data from the image data storage unit 202, decodes the image data, and sends it to the image formation unit 106.

In addition, as seen in the description of the portions in the aforementioned structure, the function of the image data generation unit 201 and the image data decoding unit 203, activated or generated by the execution of a prescribed control program previously stored in the ROM (Read Only Memory), not shown, by the CPU (Microprocessor), not shown, is represented in a block format.

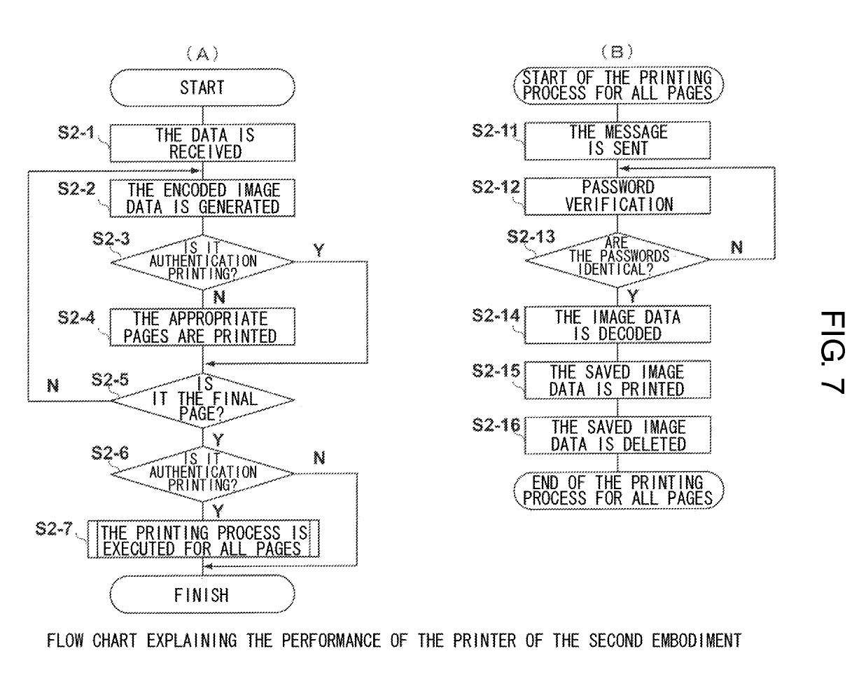

FIG. 7 is a flow chart describing the performance of the printer of the second embodiment.

(A) is a flow chart showing all of the performances and (B) is a flow chart showing process of printing all of the pages.

The overall performance of the printer 1012 (FIG. 6) will be specifically described in order from step S2-1 to step S2-7 using the flow chart (A).

Step S2-1

The transmission unit 101 (FIG. 6) receives the print job from the host computer 1001 (FIG. 1) via the communication line 1003 (FIG. 1). From the print job, the job information 102-1 is analyzed (and the password is acquired if included) by the received data analysis unit 102 (FIG. 6) and the page information 102-2 (FIG. 3), which follows after, is sent to the image data generation unit 201 (FIG. 6).

Step S2-2

The image data generation unit 201 (FIG. 6) generates one page of image data based on the received page information 102-2 (FIG. 3), encodes the image data, and stores the generated image data in the image data storage unit 202 (FIG. 6).

Step S2-3

In a case where the received data analysis unit 102 (FIG. 6) does not acknowledge the authenticated printing at the aforementioned step S2-1, the process proceeds to step S2-4. In a case where the authenticated printing is acknowledged, the process proceeds to step S2-5.

Step S2-4

Under the control of the printing control unit 105 (FIG. 6), the image formation unit 106 (FIG. 6) reads the image data from the image data storage unit 202 (FIG. 6) and performs the printing process for the appropriate page.

Step S2-5

Upon detection by the received data analysis unit 102 (FIG. 6) of the data completion information 102-3 (FIG. 3) from the print job, the process proceeds to step S2-6. The steps S2-2 through S2-5 are repeated until the data completion information 102-3 (FIG. 3) is detected.

Step S2-6

In a case where the received data analysis unit 102 (FIG. 6) does not acknowledge the authenticated printing at the aforementioned step S2-1, the process flow is finished. In a case where the authenticated printing is acknowledged, the process proceeds to step S2-7.

Step S2-7

The printing process for all of the pages (step S2-11 through step S2-16, described later) is performed and the process flow is finished.

Next, the overall performance of the printing process of all of the pages will be specifically described in order from step S2-11 to step S2-16 using the flow chart (B).

S2-11

When the image data generation unit 201 (FIG. 6) generates the image data of all of the pages based on the page information 102-2 (FIG. 3) and completes the storage of the image data in the image data storage unit 202 (FIG. 6), the transmission unit 101 (FIG. 6), based on the instructions of the printing control unit 105 (FIG. 6) sends the notification of printing preparation completion to the host computer 1001 (FIG. 1) via the communication line 1003 (FIG. 1) and displays the message shown in FIG. 4 in the display unit of the host computer 1001 (FIG. 1), not shown.

Step S2-12

The user who receives the notification of printing preparation completion moves near to the printer 1002 (FIG. 1) and executes the printing request by inputting his personal password into the password input unit 108 (FIG. 6). Upon receiving the password input by the user via the password input unit 108 (FIG. 6), the password verification unit 107 (FIG. 6) verifies this password and the password acquired by the received data analysis unit 102 (FIG. 6) as shown in step S2-1.

Step S2-13

In a case where both of the passwords are identical, the password verification unit 107 sends the verification success notification to the printing control unit 105 (FIG. 6) and proceeds to step S2-14. In a case where the passwords are not identical, the process returns to step S2-12.

Step S2-14

The image data decoding unit 203 (FIG. 6) receives the encoded image data from the image data storage unit 202 (FIG. 6), decodes the data, and sends it to the image formation unit 106 (FIG. 6).

Step S2-15

Upon receiving the verification success notification, the printing control unit 105 (FIG. 6) controls the image formation unit 106 (FIG. 6) to initiate the printing process.

Step S2-16

The printing control unit 105 (FIG. 6) deletes the image data stored in the image formation unit 106 (FIG. 6) and finishes the process flow.

As described above, in the present invention, the size of the image data can be decreased because the image data is encoded and stored and, adding this to the benefits of the first embodiment, the storage apparatus can be effectively used.

### Third Embodiment

In the aforementioned second embodiment, the image data is encoded and the size of the image data is decreased to effectively use the storage apparatus, but in the present embodiment, a storage capacity monitoring unit is equipped and, when the remaining capacity of the image data storage unit becomes small, generation of the image data is temporarily halted and a request is made to the user concerning how to proceed.

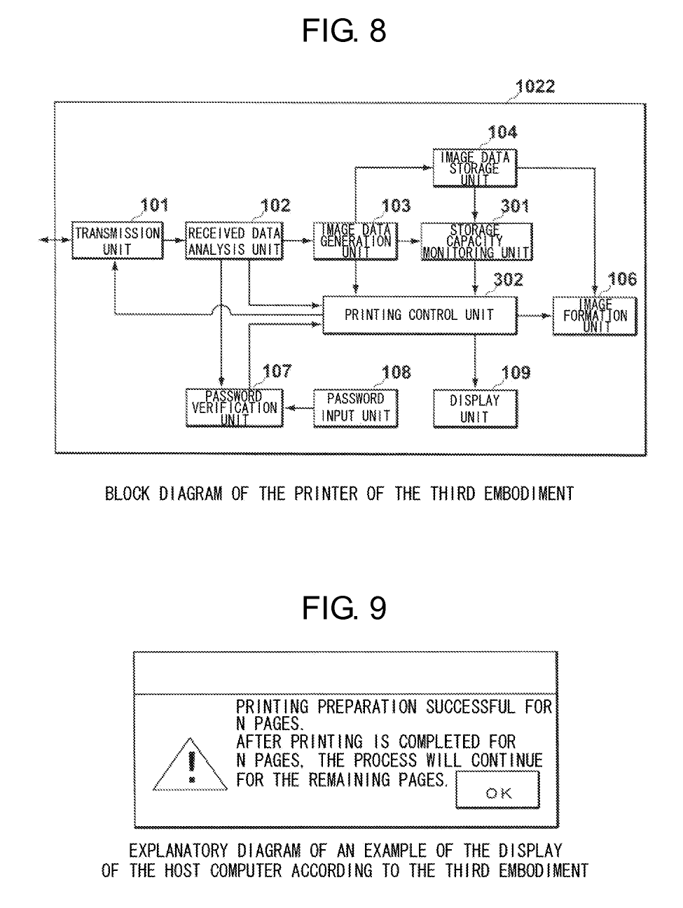

FIG. 8 is a block diagram of the printer of the third embodiment. As shown in FIG. 8, the printer 1022 according to the third embodiment is equipped with the transmission unit 101, the received data analysis unit 102, the image data generation unit 103, the image data storage unit 104, a printing control unit 302, the image formation unit 106, the password verification unit 107, the password input unit 108, the display unit 109, and a storage capacity monitoring unit 301. Below, only the portions different from those of the first embodiment will be described in detail. Portions that are substantially identical to those of the first embodiment are given the same numbering and the description is omitted.

The storage capacity monitoring unit 301 is a portion that monitors the amount of free memory of the image data storage unit 104, makes a judgment as to whether the next page of image data can be stored, and, in a case where the judgment is that the next page cannot be stored, sends a notification that storage is impossible to the printing control unit 302. The judgment may be made according to the physical memory capacity of the image data storage unit 104, or the judgment can be made based on a limit set by every user, for example.

In the case of an unauthenticated printing process, the printing control unit 302 is a portion that controls the image formation unit 106 to perform the printing process upon completion of the generation of the page data by the image data generation unit 103. In the case of an authenticated printing process, the printing control unit 302 is a portion that controls the image formation unit 106 to perform the printing process of authenticated printing upon receiving the verification success notification from the password verification unit 107. Further, upon receiving the notification that the generation of the image data based on the packet of printing information from the image data generation unit 103 is completed, the printing control unit 302 instructs the transmission unit 101 to send the notification of printing preparation completion to the host computer 1001 (FIG. 1). Especially in the example of the present embodiment, upon receiving the aforementioned notification that storage is impossible from the storage capacity monitoring unit 301, the performance of the image data generation unit 103 is temporarily halted and the printing control unit 302 instructs the transmission unit 101 to send the message concerning the halted status to the host computer 1001 (FIG. 1)

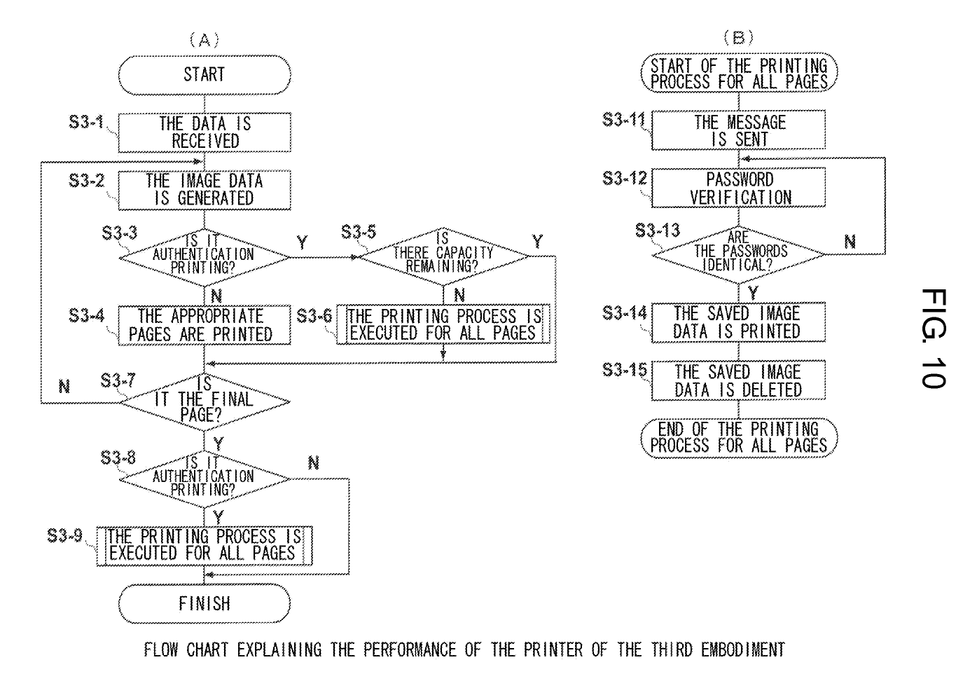

FIG. 9 is an explanatory diagram of an example display on the host computer of the third embodiment.

FIG. 9 shows an example of a message sent from the transmission unit 101 to the host computer 1001 (FIG. 1) via the communication line 1003 (FIG. 1), concerning the completion of N pages of image data generation and subsequent execution of the process for the remaining pages.

The user located near the host computer 1001 (FIG. 1) moves near the printer 1002 (FIG. 1) after confirming the display shown in FIG. 9, and executes the printing initiation request by inputting his personal password into the password input unit 108. The password verification unit 107 receives the password received by the password input unit 108 and the password acquired from the job information 102-1 (FIG. 3), and verifies both passwords.

Upon detecting that both passwords are identical, the password verification unit 107 sends the verification success notification to the printing control unit 302. Upon receiving the verification success notification, the printing control unit 302 controls the image formation unit 106 to initiate the printing process because at this time N pages of image data are already created and stored in the image data storage unit 104. The printing process for the image data is performed and, when the image data is deleted from the image data storage unit 104, the printing control unit 302 controls the image data generation unit 103 to resume the performance of the process for the remaining pages. The following is a detailed explanation using the flow chart.

FIG. 10 is a flow chart describing the performance of the printer of the third embodiment.

(A) is a flow chart showing all of the performances and (B) is a flow chart showing process of printing all of the pages. The flow chart (B) is limited to the description of a case where the printing control unit 302 (FIG. 8) receives the aforementioned notification that storage is impossible from the storage capacity monitoring unit 301. In a case where the notification that storage is impossible is not received, the process is the same as that of the first embodiment ((B) of FIG. 5) and therefore the description is omitted.

The overall performance of the printer 1022 (FIG. 6) will be specifically described in order from step S3-1 to step S3-9 using the flow chart (A).

Step S3-1

The transmission unit 101 (FIG. 8) receives the print job from the host computer 1001 (FIG. 1) via the communication line 1003 (FIG. 1). From the print job, the job information 102-1 is analyzed (and the password is acquired if included) by the received data analysis unit 102 (FIG. 8) and the page information 102-2 (FIG. 3), which follows after, is sent to the image data generation unit 103 (FIG. 8).

Step S3-2

The image data generation unit 103 (FIG. 8) generates one page of image data based on the received page information 102-2 (FIG. 3) and stores the generated image data in the image data storage unit 104 (FIG. 8).

Step S3-3

In a case where the received data analysis unit 102 (FIG. 8) does not acknowledge the authenticated printing at the aforementioned step S3-1, the process proceeds to step S3-4. In a case where the authenticated printing is acknowledged, the process proceeds to step S3-5.

Step S3-4

Under the control of the printing control unit 302 (FIG. 8), the image formation unit 106 (FIG. 8) reads the image data from the image data storage unit 104 (FIG. 8) and performs the printing process for the appropriate page.

Step S3-5

The storage capacity monitoring unit 302 (FIG. 8) monitors the amount of free memory of the image data storage unit 106 (FIG. 8) and makes a judgment as to whether the next page of image data can be stored. In a case where the judgment is made that the next page of image data cannot be stored, the storage capacity monitoring unit 302 (FIG. 8) sends the notification that storage is impossible to the printing control unit 302 and the process proceeds to step S3-6. In a case where the judgment is made that the next page of image data can be stored, the process proceeds to step S3-7.

Step S3-6

The printing process for all of the pages (step S3-11 through step S3-15, described later) is performed and the process proceeds to step S3-7.

Step S3-7

Upon detection by the received data analysis unit 102 (FIG. 8) of the data completion information 102-3 (FIG. 3) from the print job, the process proceeds to step S3-8. The steps S3-2 through S3-7 are repeated until the data completion information 102-3 (FIG. 3) is detected.

Step S3-8

In a case where the received data analysis unit 102 (FIG. 8) does not acknowledge the authenticated printing at the aforementioned step S3-1, the process flow is finished. In a case where the authenticated printing is acknowledged, the process proceeds to step S3-9.

Step S3-9

The printing process for all of the pages (step S3-11 through step S3-15, described later) is performed and the process flow is finished. It is to be noted that, because the passwords have already been verified to be identical, step S1-11 through step S1-13 may be omitted, for example.

Next, the overall performance of the printing process of all of the pages will be specifically described in order from step S3-11 to step S3-15 using the flow chart (B).

Step S3-11

Upon receiving the notification that storage is impossible from the storage capacity monitoring unit 301 (FIG. 8), the printing control unit 302 temporarily halts the performance of the image data generation unit 103 (FIG. 8), instructs the transmission unit 101 (FIG. 8) to send the message described in FIG. 9 to the host computer 1001 (FIG. 1) via the communication line 1003 (FIG. 1). The message is displayed in the display unit, not shown, of the host computer 1001 (FIG. 1), N pages of image data is previously created by the user and stored in the data storage unit 104, and notifies the user that the process can be performed for the remaining pages (printing preparation completion) after the printing of N pages is completed.

Step S3-12

The user who receives the notification of printing preparation completion moves near to the printer 1002 (FIG. 1) and executes the printing request by inputting his personal password into the password input unit 108 (FIG. 8). Upon receiving the password input by the user via the password input unit 108 (FIG. 8), the password verification unit 107 (FIG. 8) verifies this password and the password acquired by the received data analysis unit 102 (FIG. 8) as shown in step S3-1.

Step S3-13

In a case where both of the passwords are identical, the password verification unit 107 sends the verification success notification to the printing control unit 302 (FIG. 8) and proceeds to step S3-14. In a case where the passwords are not identical, the process returns to step S3-12.

Step S3-14

Upon receiving the verification success notification, the printing control unit 302 (FIG. 8) controls the image formation unit 106 (FIG. 8) to initiate the printing process.

Step S3-15

The printing control unit 302 (FIG. 8) deletes the image data stored in the image formation unit 106 (FIG. 8) and finishes the process flow.

The present embodiment described above is equipped with the storage capacity monitoring unit 301 (FIG. 8) and, because the storage capacity monitoring unit 301 (FIG. 8) operates to monitor the remaining amount of memory of the image data storage unit 104 (FIG. 8), this benefit can be added to the first embodiment without encoding the image data (as in the second embodiment), thereby achieving the benefit of effectively using the storage apparatus.

The description above is of a case where the present invention is applicable to a printer, but the present invention is not limited to this. That is, the present invention can also be applied to a fax machine, copy machine, or the like.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

What is claimed is:

1. An image forming apparatus comprising:
an image data generation unit for generating image data based on input printing information;
an image data storage unit for storing the image data;
a reception completion judgment unit for making a judgment as to whether reception of a packet of printing information is completed;
a notification unit for giving notification of printing preparation completion upon completion of the image data generation based on the packet of the printing information judged to be received;
a print order unit for receiving a printing initiation request based on the notification of printing preparation completion and ordering initiation of printing; and
an image formation unit for performing a printing process, based on orders from said print order unit, of the image data based on the packet of printing information.

2. The image forming apparatus according to claim 1, further comprising a verification authentication unit for verifying authentication information added to the packet of printing information and authentication information added to the printing initiation request, and for making a judgment as to whether the two sets of authentication information are identical, wherein said print order unit orders printing initiation based on the judgment made by said verification authentication unit that the two sets of authentication information are identical.

3. The image forming apparatus according to claim 1, further comprising an image data decoding unit for decoding encoded image data, wherein:
said image data generation unit generates image data based on the input printing information and further encodes the image data; and
said image formation unit performs the printing process for the image data decoded by said image data decoding unit.

4. The image forming apparatus according to claim 2, further comprising an image data decoding unit for decoding encoded image data, wherein:
said image data generation unit generates image data based on the input printing information and further encodes the image data; and
said image formation unit performs the printing process for the image data decoded by said image data decoding unit.

5. The image forming apparatus according to claim 1, comprising a storage capacity monitoring unit for monitoring the remaining capacity of said image data storage unit, wherein said notification unit gives notification of the printing preparation completion upon decrease of the remaining amount to a predetermined level.

6. The image forming apparatus according to claim 2, comprising a storage capacity monitoring unit for monitoring the remaining capacity of said image data storage unit, wherein said notification unit gives notification of the printing preparation completion upon decrease of the remaining amount to a predetermined level.

7. The image forming apparatus according to claim 3, comprising a storage capacity monitoring unit for monitoring the remaining capacity of said image data storage unit, wherein said notification unit gives notification of the printing preparation completion upon decrease of the remaining amount to a predetermined level.
